(19) United States
(12) Patent Application Publication
(10) Pub. No.: US 2003/0207604 A1
(43) Pub. Date: Nov. 6, 2003

(54) Module connector assembly and method therefor

(75) Inventors: David W. Burger, Chippewa Falls, WI (US); Bradley J. Smith, Eau Claire, WI (US)

Correspondence Address: Schwegman, Lundberg, Woessner & Kluth, P.A., P.O. Box 2938, Minneapolis, MN, 55402, US

(73) Assignee: Cray Inc.

(21) Appl. No.: 10/137,831

(22) Filed: May 1, 2002

(51) Int. Cl. H01R 13/62

(52) U.S. Cl. 439/310

(57) ABSTRACT

A module connector assembly includes a mounting apparatus, and at least one module assembly coupled with a portion of the mounting apparatus, where the at least one module assembly includes a plurality of electronic components that are coupled to the module assembly. The module connector assembly further includes one or more shuttle assemblies coupled with the module assembly with a shuttle cable. The module connector assembly further includes at least one flexible circuit cable assembly and/or a twin axial cable assembly electrically coupled with one or more of the shuttle assemblies. Optionally, the shuttle cable includes one or more metal layers.

### TECHNICAL FIELD

The present invention relates to a module connector assembly for electronic components such as computers.

### BACKGROUND

Electronic systems have printed circuit board assemblies, sometimes referred to herein as modules or module assemblies, that contain signals for communication, control, and power. As assemblies become more complex, the number of electrical data signals increase and data rate increases certain problems arise. At some point it is difficult to achieve the input/output requirements of a particular assembly.

High speed electronic digital computers of the type produced by Cray, Inc., the assignee hereof, generally utilize densely packaged or stacked banks of circuit modules. Each circuit module typically includes a heat sink or “cold plate” sandwiched between a pair of printed circuit boards carrying thereon a number of circuit, logic and memory devices including numerous integrated circuits. Each circuit module also typically includes a pair of edge connector assemblies disposed adjacent opposite edges of each circuit board for conductively connecting each board with other boards and modules of the computer.

The edge connector assemblies generally have a plurality of slidable female connector blocks mounted to the cold plate adjacent the edges of the circuit boards with each electrical contact then conductively connected to the boards. A plurality of male connector pins are generally affixed to stationary blocks mounted to mounting rails. The male connectors are coupled together with coaxial or a twisted pair, as mentioned in U.S. Pat. No. 4,984,993, issued to Cray Research, Inc., on Jan. 15, 1991. The female connector blocks then engage the male connector pins when the circuit module is installed within the computer.

What is needed is an apparatus which provides for increased flexibility in the interconnection of module assemblies while still allowing high speed communication.

### SUMMARY

A module connector assembly includes a mounting apparatus, and at least one module assembly coupled with a portion of the mounting apparatus, where the at least one module assembly includes a plurality of electronic components that are coupled to the module assembly. The module connector assembly further includes one or more shuttle assemblies coupled with the module assembly with a shuttle cable. The module connector assembly further includes at least one flexible circuit cable assembly electrically coupled with one or more of the shuttle assemblies.

Several options for the module connector assembly are as follows. For instance, in one option, the shuttle cable includes two or more layers of metal, and optionally one or more of the layers of metal is a ground plane. In yet another option, the shuttle cable includes differential traces thereon. The module connector assembly further includes, in another option, a plurality of module assemblies. The flexible circuit cable assembly extends between a first module assembly and a second module assembly, and the flexible circuit cable assembly electrically couples the first module assembly with the second module assembly. Still further, in another option, the flexible circuit cable assembly is mechanically coupled with the mounting apparatus. In yet another option, the mounting apparatus is mounted within a cabinet, and the mounting apparatus includes mounting rails, and optionally the flexible circuit cable assembly is statically mounted to one of the mounting rails. In another option, the shuttle assembly includes a shuttle housing, where one or more flanges extend from the shuttle housing.

In another embodiment, a module connector assembly includes a mounting apparatus, and at least one module assembly coupled with a portion of the mounting apparatus, where a plurality of electronic components are coupled to the module assembly. The module connector assembly further includes one or more shuttle assemblies dynamically coupled with the module assembly, where the one or more shuttle assemblies are electrically coupled with the module assembly with a shuttle cable. The module connector assembly further includes at least one twin axial cable assembly including a first pin header and a second pin header, at least the first pin header mechanically coupled with the mounting apparatus, the at least one twin axial cable assembly electrically coupled with the one or more shuttle assemblies.

Several options for the module connector assembly are as follows. For instance, the module connector assembly includes the above-discussed options. Alternatively or additionally, the module connector assembly further optionally includes a plurality of module assemblies, the twin axial cable assembly extends between a first module assembly and a second module assembly, and the twin axial cable assembly electrically couples the first module assembly with the second module assembly.

In another embodiment, a module connector assembly includes a mounting apparatus, a module assembly coupled with a portion of the mounting apparatus, and a plurality of electronic components coupled to the mounting apparatus. The module connector assembly further includes one or more shuttle assemblies dynamically coupled with the module assembly, where the one or more shuttle assemblies are electrically coupled with the module assembly with a shuttle cable. The shuttle cable includes two or more flexible metal layers, and at least one metal layer is a signal layer. Several options for the module connector assembly are as follows. For instance, the module connector assembly includes the above-discussed options. In another option, the module connector assembly further includes a plurality of module assemblies, the flexible circuit cable assembly extends between a first module assembly and a second module assembly, and the flexible circuit cable assembly electrically couples the first module assembly with the second module assembly. In yet another option, the module connector assembly further includes a plurality of module assemblies, the twin axial cable assembly extends between a first module assembly and a second module assembly, and the twin axial cable assembly electrically couples the first module assembly with the second module assembly.

In another embodiment, a method includes dynamically coupling one or more shuttle connectors with one or more module assemblies, including a first module assembly and a second module assembly, including coupling the one or more shuttle connectors with one or more module assemblies with a shuttle cable having two or more metal layers. The method further includes mounting a plurality of module assemblies within a mounting apparatus, mounting a plurality of cables to the mounting apparatus, and electrically coupling the plurality of cables with the one or more shuttle connectors.

Several options for the method are as follows. For instance, in one embodiment, mounting the plurality of mounting assemblies comprises mounting the modules within mounting rails. In another option, a cable includes a first cable pin header on one end of the cable and a second cable pin header on the other end of the cable, and the method further includes mechanically coupling the first cable pin header to a first mounting rail adjacent a first module assembly and mechanically coupling the second cable pin header to a second mounting rail adjacent a second module assembly. In another option, mounting the plurality of cables to the mounting apparatus includes mechanically mounting a plurality of flexible circuits to the mounting apparatus. In yet another option, mounting the plurality of cables to the mounting apparatus includes mechanically mounting a plurality of twin axial cables to the mounting apparatus. The method further optionally includes electrically coupling a first module edge with a second module edge with at least one of the plurality of cables.

The module connector system allows for high-speed communication between module assemblies, for example, at speeds of 800 Mb/s and greater that wasn't possible with previous designs. Cross-talk has been greatly reduced by the module connector system, for example, by the unique use of cables in the system. Furthermore, the system allows for convenient assembly and disassembly. The components of the system provide for many different set-ups which may require module assemblies located further apart than previous designs.

These and other embodiments, aspects, advantages, and features of the present invention will be set forth in part in the description which follows, and in part will become apparent to those skilled in the art by reference to the following description of the invention and referenced drawings or by practice of the invention. The aspects, advantages, and features of the invention are realized and attained by means of the instrumentalities, procedures, and combinations particularly pointed out in the appended claims and their equivalents.

### BRIEF DESCRIPTION OF THE DRAWINGS

FIG. 1 is a perspective view illustrating a system including module connector assemblies constructed in accordance with one embodiment.

FIG. 2 is a top plan view illustrating a portion of module connector assemblies constructed in accordance with one embodiment.

FIG. 3A is an end view illustrating a shuttle assembly constructed in accordance with one embodiment.

FIG. 3B is a perspective view illustrating a shuttle housing constructed in accordance with one embodiment.

FIG. 4 is a perspective view illustrating a shuttle connector and a shuttle cable constructed in accordance with one embodiment.

FIG. 5 is a top plan view illustrating a portion of module connector assemblies constructed in accordance with one embodiment.

FIG. 6 is a perspective view illustrating a module connector assembly constructed in accordance with one embodiment.

FIG. 7A is a top plan view of a portion of a cable assembly constructed in accordance with one embodiment.

FIG. 7B is a side view of a cable assembly constructed in accordance with one embodiment.

FIG. 7C is an end view of a cable assembly constructed in accordance with one embodiment.

FIG. 8A is a top plan view of a portion of a cable assembly constructed in accordance with one embodiment.

FIG. 8B is a side view of a portion of a cable assembly constructed in accordance with one embodiment.

FIG. 8C is an end view of a cable assembly constructed in accordance with one embodiment.

### DESCRIPTION OF THE EMBODIMENTS

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that structural changes may be made without departing from the scope of the present invention. Therefore, the following detailed description is not to be taken in a limiting sense, and the scope of the present invention is defined by the appended claims and their equivalents.

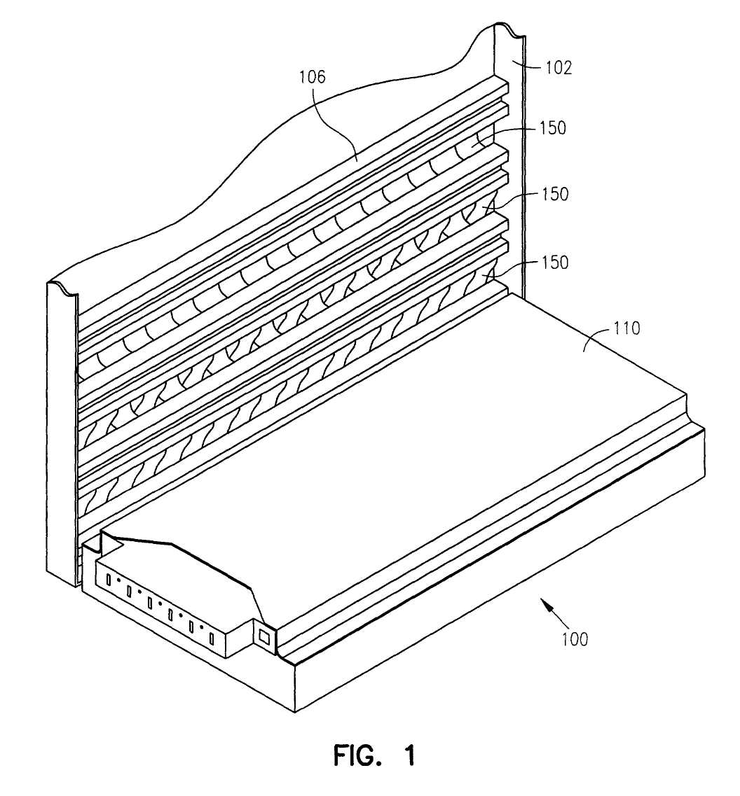

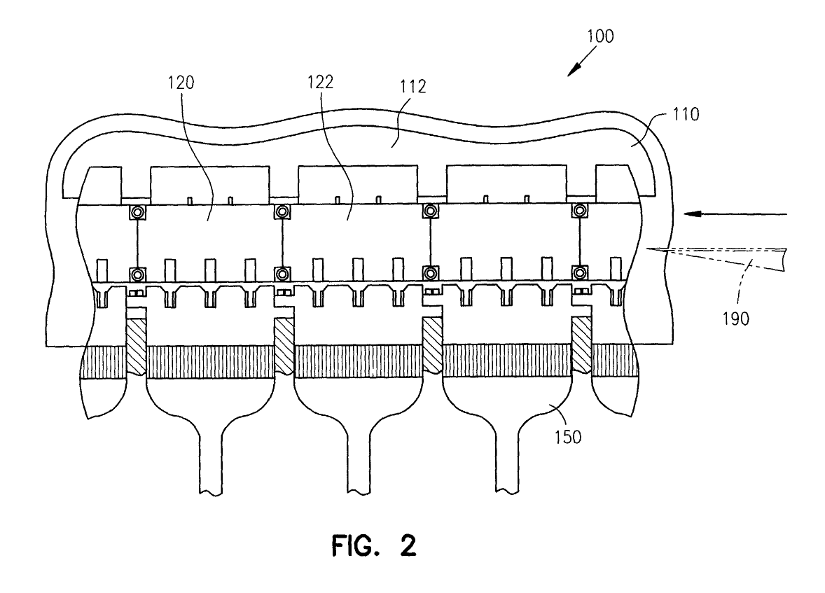

FIG. 1 illustrates a system 100 constructed in accordance with one embodiment. The system 100 includes a cabinet 102 with a mounting apparatus therein. In one option, the mounting apparatus includes one or more mounting rails 106, as further discussed below. The mounting apparatus allows for a module assembly 110 to be coupled therewith. Module assembly 110 includes, among other things, routers, node modules, etc. The system 100 further includes a cable assembly 150. The cable assembly 150, as further described below, allows for a module assembly 110 coupled with a mounting rail 106 to communicate with another module assembly 110, where the cable assembly 150 extends from a first end to a second end, and each end is coupled with the mounting rail 106. The module assembly 110 further includes a shuttle assembly 120, shown in greater detail in FIG. 2.

The shuttle assembly 120 is coupled with a cold plate 112 of the module assembly 110. The shuttle assembly 120 includes a shuttle housing 122 mounted to the cold plate 112 of the module assembly 110. It should be noted, however, that the shuttle housing 122 can be mounted in other locations, such as, but not limited to, on the printed circuit board. A cable assembly 150, as further discussed below, opposes each shuttle housing 122.

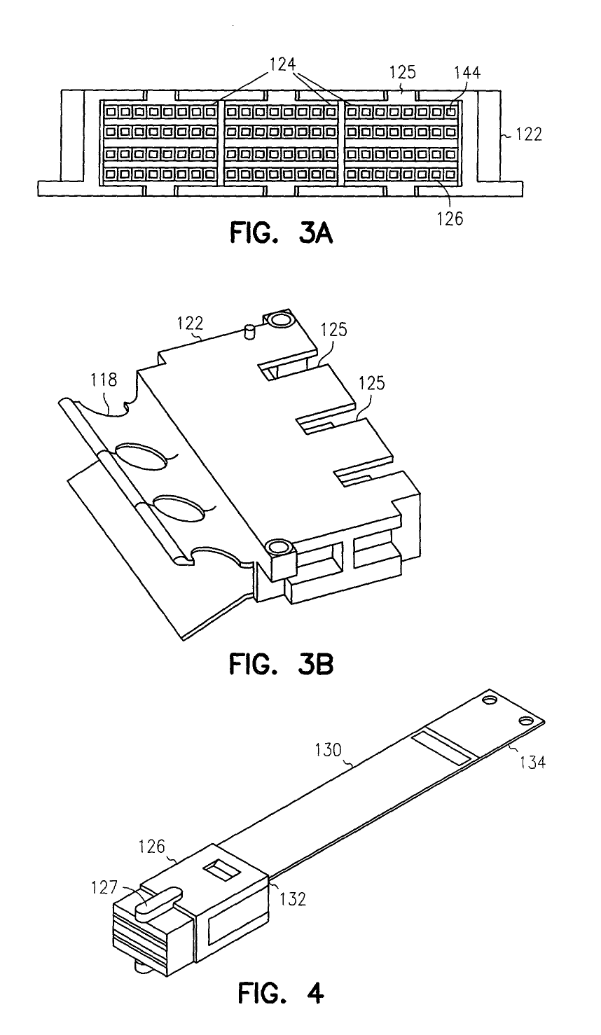

The shuttle housing 122 includes, in one option, shuttle bays 124, for example, three shuttle bays 124 formed therein, as shown in FIG. 3A. The shuttle bays 124 each receive therein a shuttle connector 126. The shuttle housing 122 further includes, in another option, open alignment slots 125. The open alignment slots 125 receive therein an alignment feature 127 (FIG. 4), where the alignment feature 127 aligns each shuttle connector 126 relative to the shuttle housing 122. In another embodiment, as shown in FIG. 3B, the shuttle housing 122 includes one or more flanges 118. The flanges 118 extend out away from an edge of the shuttle housing 122, and in one option, form a general V-shape, when two flanges 118 are supplied to the shuttle housing 122. The shuttle cable 130 (FIG. 4) is received within the shuttle housing 122 between the two flanges 118. The flanges 118 assist in providing strain relief for the shuttle cable 130 (FIG. 4), for example, as the shuttle connectors 126 move within the shuttle bays 124.

The shuttle connectors 126 are movably disposed within the shuttle bays 124 of the shuttle housing 122 for movement toward and away from the adjacent cable assembly 150 (FIG. 2). The shuttle connector 126 provides the female portion which connects with the pins of the cable assembly 150 (FIG. 2), as discussed below. Coupled with the shuttle connector 126 is a shuttle cable 130, as shown in more detail in FIG. 4.

The shuttle cable 130 establishes the electrical connection between the module assembly 110 (FIG. 1) and the shuttle connector 126, and allows for electrical communication with the cable assembly 150 (FIG. 2), where the cable assembly 150 (FIG. 2) allows for high speed communication between module assemblies 110 (FIG. 1).

The shuttle cable 130 extends from a first end 132 to a second end 134. The first end 132 of the shuttle cable 130 is coupled with the shuttle connector 126, and the second end 134 is electrically coupled with the printed circuit board. To attach the shuttle cable 130 to the module assembly 110, a portion of the flexible shuttle cable 130 is ablated, and flying leads in the ablated region of the cable 130 are attached to the module assembly 110 using a hotbar. The flying leads are fragile, and in one option, an adhesive process and strain relief bar and/or spring are used to provide strain relief to the flying leads as the shuttle connector 126 dynamically moves within the shuttle housing 122 (FIG. 3).

The shuttle cable 130, in one option, includes at least two metal layers, where more than two metal layers are possible as well. In one option, a first metal layer comprises a signal layer, and a second metal layer comprises a ground plane. In another option, the shuttle cable 130 includes differential traces. The differential traces provide for differential transmission of electrical signals. The shuttle cable 130 significantly reduces the amount of cross-talk, and assists in communicating signals at high speeds, for example at data rates of 800 Mb/s, and further assists in allowing for increased density in the shuttle assembly.

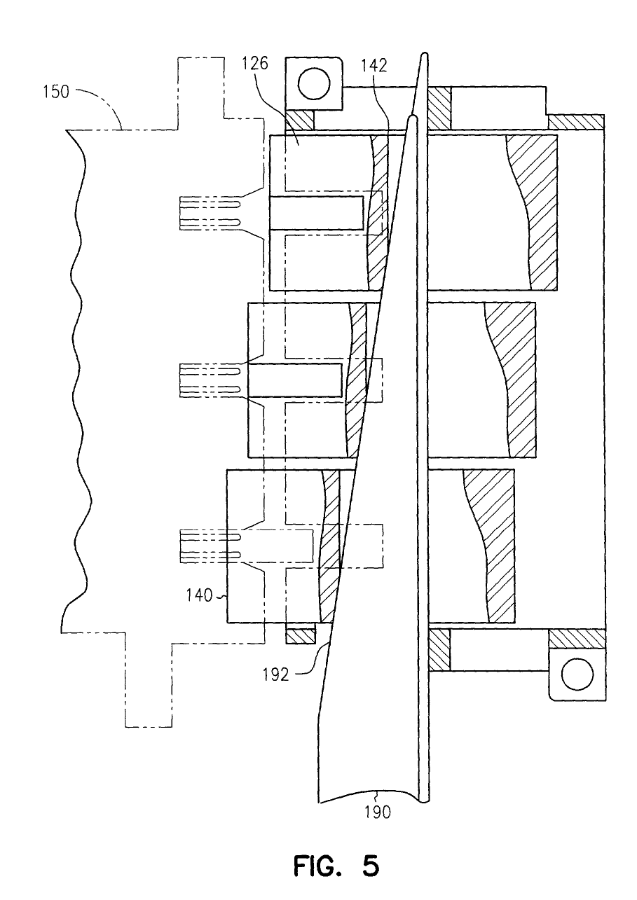

Referring to FIG. 5, each shuttle cable 130 includes a terminal portion 140 located adjacent the cable assembly and a cam portion 142 located away from the cable assembly 150, and optionally integrally joined to the terminal portion 140. The terminal portion includes rows of closely spaced cavities 144 (FIG. 3), each opening on a front face of the shuttle assembly.

A sliding tool 190 is used to impart a transverse movement to the shuttle connectors 126. The sliding tool 190 moves the shuttle connectors 126 toward the cable assembly 150 and assists in electrically connecting the shuttle assembly with the cable assembly 150. The sliding tool 190 and its use relative to the shuttle assembly are further described in U.S. Pat. Nos. 4,975,074 and 4,984,993, which are each incorporated herein by reference. The sliding tool 190 has a tapering edge 192. The angle of tapering edge 192 is a factor in the mechanical resistance encountered when connecting the male pins and female receptacles. Other cam-like devices and equivalents could be used. For example, a cam having a “single” cam edge or a plurality of cams arranged and configured so as to impart transverse movement to the shuttle connector 126 may be used.

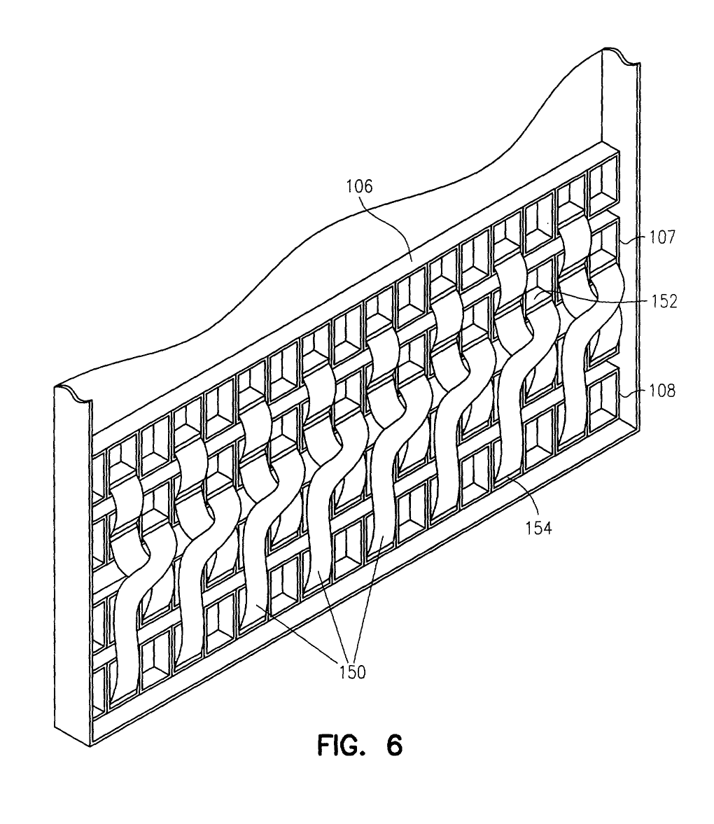

As mentioned above, the shuttle assemblies are electrically coupled with a cable assembly 150. The cable assemblies 150, in one option, are mounted on the mounting rail 106, as shown in FIGS. 1 and 6. The cable assemblies 150 each extend from a first end 152 to a second end 154. The first end 152 of the cable assembly, in one option, is coupled with a first rail 107, and the second end 154, in one option, is coupled with a second rail 108, allowing for external electrical communication between two rails 106 and two different module assemblies. For example, electrical communication occurs, in one option, at the edges of the module assemblies, which are mounted in the mounting apparatus. In another option, multiple cable assemblies 150 are interconnected and each end of the interconnected multiple cable assemblies 150 are coupled with two different module assemblies. For example, a double female connector would be disposed between a first cable assembly and a second cable assembly, allowing them to be interconnected.

As mentioned above, in one option, the mounting apparatus includes one or more mounting rails 106, as shown in FIG. 1. It should be noted that other forms for the mounting apparatus are included within the scope of the application. The mounting rails 106 allow for a module assembly 110 to be coupled therewith. In one option, a single module assembly 110 is coupled with a single mounting rail 106. In another option, a plurality of module assemblies 110 are provided within the cabinet 102, where one or more module assemblies 110 are mounted to the mounting rails 106.

The mounting rails 106 are constructed from a substantially rigid material having substantially planar upper surfaces and substantially planar lower surfaces spaced apart from and generally parallel to the upper surfaces. The width between the upper and lower surfaces is substantial enough to provide sufficient rigidity and dimensional tolerance for accurate positioning of the shuttle housing. In one option, a plurality of connector mounting openings are formed on an outer side of the rails 106. The connector mounting openings receive the pin headers of the cable assemblies therein.

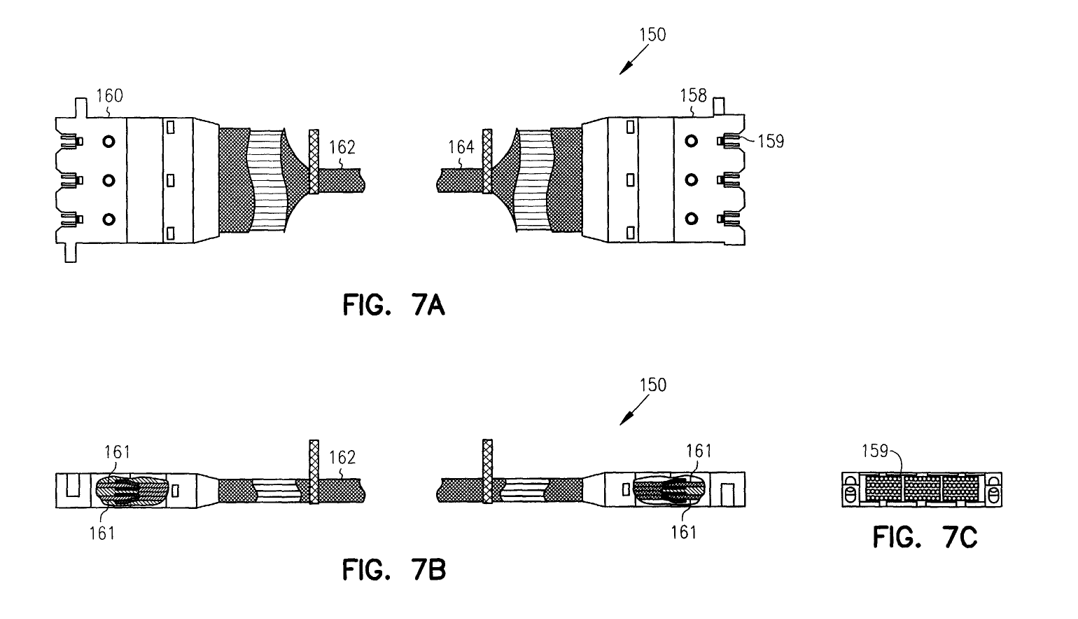

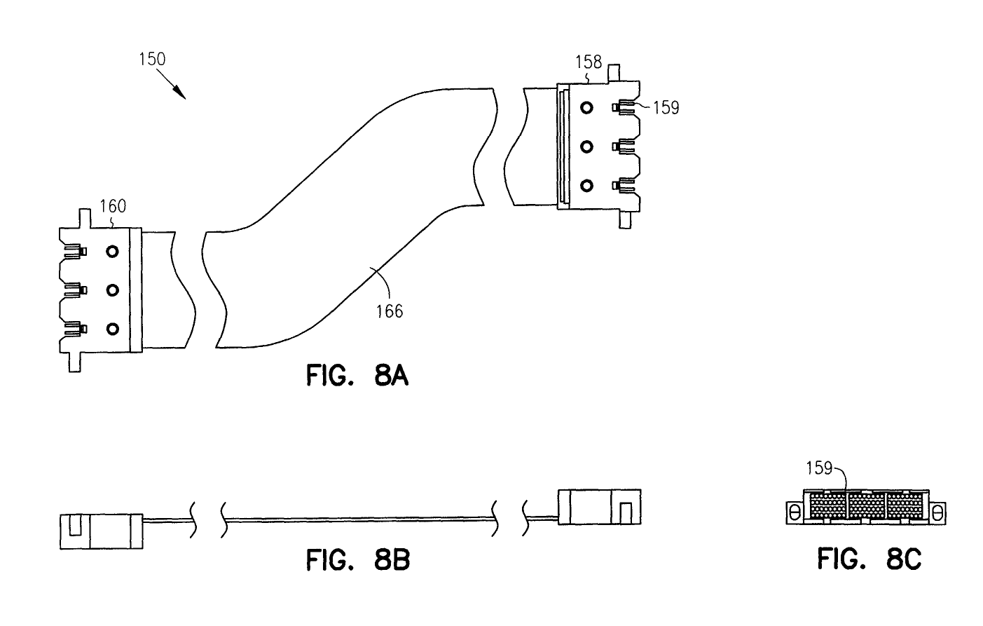

The cable assemblies, shown in more detail in FIGS. 7A, 7B, 7C, 8A, 8B and 8C, include a first chassis pin header 158 and a second chassis pin header 160 disposed at either end of the cable assembly 150. The first chassis pin header 158 and the second chassis pin header 160 each include a plurality of pins 159 therein. For instance, in one option, each pin header includes 96 pins, which mate with 96 receptacles of the shuttle assembly (FIG. 3). The first chassis pin header 158 and the second chassis pin header 160 further include a connector to suitably couple with the shuttle housing (FIG. 3). The first chassis pin header 158 and the second chassis pin header 160 further include at least one paddle card 161 which are electrically coupled with one another. A cable 162 connects the first chassis pin header and the second chassis pin header.

In one option, the cable comprises a twin axial cable 164, as shown in FIG. 7A, where the twin axial cable 164 includes two paddle cards. The wired twin-axial cable uses ‘common-header’ between paddle cards to transfer ground from lower ground pair pins to the signal reference and shield grounds in an upper paddle board. Both connector ends with paddle board/header assemblies carry the logic ground by connection to 6 pins on each end of the cable. Individual twin-axial shield drain wires are bonded to the respective paddle boards. In another option, the cable comprises a flexible circuit cable 166, as shown in FIGS. 8A, 8B, and 8C, and includes, for example, a three metal flexible circuit cable. In one option, the flexible circuit cable 166 includes a ground plane metal layer to common the ground pin pairs and carry an impedance reference for the two signal layers and between both connector ends. The flexible circuit cable 166, in one option, has a wave shape. The flexible circuit cable can come in a variety of lengths, such as, but not limited to, about 6 inches which can be used for neighboring module assemblies. In another option, the flexible circuit cable has a length of about 12 inches.

In assembling the module connector assembly 100, as shown in FIG. 5, the cable assemblies are coupled with the mounting apparatus and the module assemblies are coupled with the mounting apparatus. The shuttle assemblies are moved into a connected position with the cable assemblies. For instance, each of the shuttle connectors 126 start in a non-operational position fully retracted within the shuttle housing. The cold plate (or other structure on which the shuttles are located) is then inserted into a groove in the mounting rails.

Once the cold plate is fully installed, then the sliding tool 190 is inserted into a guide slot and subsequently through a window of the shuttle housing. As the tip progresses through the window, the shuttle connector 126 is driven forward (i.e. transversely) toward the cable assembly. The shuttle is driven by the cam effect of the tapering edge of the sliding tool 190. The movement continues until the male pins of the cable assembly are inserted into the female receptacles of the shuttle connector. In this position the shuttle connector is in its operational position and is electrically coupled with the cable assembly. The shuttle cable is designed so as to allow movement of the shuttle connector into its operational position. For example, the shuttle cable is flexible and forms a loop from the shuttle connector to the cold plate.

The insertion tool 190 continues through each of the shuttle assemblies. This process continues until all shuttle connectors 126 of the shuttle assemblies have been urged transversely toward the pin headers of the cable assemblies.

To disengage the shuttle connectors 126, the insertion tool 190 is turned 180 degrees about its longitudinal axis and inserted into the rear portion of the slot and the process is reversed. By turning the tool 180 degrees, the tapering edge of the sliding tool 190 faces away from the cable assemblies.

In another embodiment, a method includes dynamically coupling one or more shuttle connectors with one or more module assemblies, including a first module assembly and a second module assembly, including coupling the one or more shuttle connectors with one or more module assemblies with a shuttle cable having two or more metal layers. The method further includes mounting a plurality of module assemblies within a mounting apparatus, mounting a plurality of cables to the mounting apparatus, and electrically coupling the plurality of cables with the one or more shuttle connectors.

Several options for the method are as follows. For instance, in one embodiment, mounting the plurality of module assemblies comprises mounting the modules within mounting rails. In another option, a cable includes a first cable pin header on one end of the cable and a second cable pin header on the other end of the cable, and the method further includes mechanically coupling the first cable pin header to a first mounting rail adjacent a first module assembly and mechanically coupling the second cable pin header to a second mounting rail adjacent a second module assembly.

In another option, mounting the plurality of cables to the mounting apparatus includes mechanically mounting a plurality of flexible circuits to the mounting apparatus. In yet another option, mounting the plurality of cables to the mounting apparatus includes mechanically mounting a plurality of twin axial cables to the mounting apparatus. The method further optionally includes electrically coupling a first module edge with a second module edge with at least one of the plurality of cables.

Advantageously, the module connector system allows for high-speed communication between module assemblies, for example, at data rates of 800 Mb/s and greater and increased bandwidth. Cross-talk has been greatly reduced by the module connector system. Furthermore, the system allows for convenient assembly and disassembly, greater modularity and product flexibility. The components of the system provide for many different set-ups which may require module assemblies located further apart than previous designs.

It is to be understood that the above description is intended to be illustrative, and not restrictive. Many other embodiments will be apparent to those of skill in the art upon reading and understanding the above description. It should be noted that embodiments discussed in different portions of the description or referred to in different drawings can be combined to form additional embodiments of the present invention. The scope of the invention should, therefore, be determined with reference to the appended claims, along with the fall scope of equivalents to which such claims are entitled.

What is claimed is:

1. A module connector assembly comprising:
a mounting apparatus;
at least one module assembly coupled with a portion of the mounting apparatus, the at least one module assembly including a plurality of electronic components coupled thereto;
one or more shuttle assemblies coupled with the module assembly, the one or more shuttle assemblies coupled with the module assembly with a shuttle cable; and
at least one flexible circuit cable assembly electrically coupled with the one or more shuttle assemblies.

2. The module connector assembly as recited in claim 1, wherein the shuttle cable includes two or more layers of metal.

3. The module connector assembly as recited in claim 2, wherein at least one of the layers of metal is a ground plane.

4. The module connector assembly as recited in claim 2, wherein the shuttle cable includes differential traces thereon.

5. The module connector assembly as recited in claim 1, further comprising a plurality of module assemblies, the flexible circuit cable assembly extends between a first module assembly and a second module assembly, and the flexible circuit cable assembly electrically couples the first module assembly with the second module assembly.

6. The module connector assembly as recited in claim 1, wherein the flexible circuit cable assembly is mechanically coupled with the mounting apparatus.

7. The module connector assembly as recited in claim 1, wherein the mounting apparatus is mounted within a cabinet, and the mounting apparatus includes mounting rails.

8. The module connector assembly as recited in claim 7, wherein the flexible circuit cable assembly is statically mounted to at least one of the mounting rails.

9. The module connector assembly as recited in claim 1, wherein the at least one of the one or more shuttle assemblies includes one or more flanges extending therefrom.

10. A module connector assembly comprising:
a mounting apparatus;
at least one module assembly coupled with a portion of the mounting apparatus, the at least one module assembly including a plurality of electronic components coupled thereto;
one or more shuttle assemblies dynamically coupled with the module assembly, the one or more shuttle assemblies electrically coupled with the module assembly with a shuttle cable; and
at least one twin axial cable assembly including a first pin header and a second pin header, at least the first pin header mechanically coupled with the mounting apparatus, the at least one twin axial cable assembly electrically coupled with the one or more shuttle assemblies.

11. The module connector assembly as recited in claim 10, wherein the mounting apparatus is mounted within a cabinet, and the mounting apparatus includes mounting rails.

12. The module connector assembly as recited in claim 10, wherein the shuttle assemblies include a shuttle cable, and the shuttle cable includes two or more layers of metal.

13. The module connector assembly as recited in claim 12, wherein at least one of the layers of metal is a ground plane.

14. The module connector assembly as recited in claim 12, wherein the shuttle cable includes differential traces thereon.

15. The module connector assembly as recited in claim 10, further comprising a plurality of module assemblies, the twin axial cable assembly extends between a first module assembly and a second module assembly, and the twin axial cable assembly electrically couples the first module assembly with the second module assembly.

16. A module connector assembly comprising:
a mounting apparatus;
at least one module assembly coupled with a portion of the mounting apparatus, the at least one module assembly including a plurality of electronic components coupled thereto; and
one or more shuttle assemblies dynamically coupled with the module assembly, the one or more shuttle assemblies electrically coupled with the module assembly with a shuttle cable, the shuttle cable including two or more flexible metal layers, and at least one metal layer is a signal layer.

17. The module connector assembly as recited in claim 16, wherein at least one metal layer is a ground plane.

18. The module connector assembly as recited in claim 16, further comprising at least one flexible circuit cable assembly electrically coupled with the one or more shuttle assemblies.

19. The module connector assembly as recited in claim 18, further comprising a plurality of module assemblies, the flexible circuit cable assembly extends between a first module assembly and a second module assembly, and the flexible circuit cable assembly electrically couples the first module assembly with the second module assembly.

20. The module connector assembly as recited in claim 16, further comprising at least one twin axial cable assembly electrically coupled with the one or more shuttle assemblies.

21. The module connector assembly as recited in claim 20, further comprising a plurality of module assemblies, the twin axial cable assembly extends between a first module assembly and a second module assembly, and the twin axial cable assembly electrically couples the first module assembly with the second module assembly.

22. A method comprising:
dynamically coupling one or more shuttle connectors with one or more module assemblies, including a first module assembly and a second module assembly, including coupling the one or more shuttle connectors with one or more module assemblies with a shuttle cable having two or more metal layers;
mounting a plurality of module assemblies within a mounting apparatus;
mounting a plurality of cables to the mounting apparatus; and
electrically coupling the plurality of cables with the one or more shuttle connectors.

23. The method as recited in claim 22, wherein mounting the plurality of module assemblies comprises mounting the module assemblies within mounting rails.

24. The method as recited in claim 22, further comprising a cable having a first cable pin header on one end of the cable and a second cable pin header on the other end of the cable, mechanically coupling the first cable pin header to a first mounting rail adjacent a first module assembly and mechanically coupling the second cable pin header to a second mounting rail adjacent a second module assembly.

25. The method as recited in claim 22, wherein mounting the plurality of cables to the mounting apparatus includes mechanically mounting a plurality of flexible circuits to the mounting apparatus.

26. The method as recited in claim 22, wherein mounting the plurality of cables to the mounting apparatus includes mechanically mounting a plurality of twin axial cables to the mounting apparatus.

27. The method as recited in claim 22, further comprising electrically coupling a first module edge with a second module edge with at least one of the plurality of cables.
